(19) United States
(12) Patent Application Publication
(10) Pub. No.: US 2025/0150985 A1
(43) Pub. Date: May 8, 2025

(54) SYSTEMS, METHODS, AND DEVICES FOR POWER SHARING BETWEEN CONTROL AND BACKHAUL LINKS OF A NETWORK-CONTROLLED REPEATER

(71) Applicant: Apple Inc., Cupertino, CA (US)

(72) Inventors: Ankit BHAMRI, Haar (DE); Hong HE, San Jose, CA (US); Wei ZENG, Saratoga, CA (US); Haitong SUN, Saratoga, CA (US); Dawei ZHANG, Saratoga, CA (US); Weidong YANG, San Diego, CA (US); Oghenekome OTERI, San Diego, CA (US)

(21) Appl. No.: 18/933,609

(22) Filed: Oct. 31, 2024

Related U.S. Application Data
(60) Provisional application No. 63/596,105, filed on Nov. 3, 2023.

(51) Int. Cl. H04W 52/34; H04W 52/36

(52) U.S. Cl. CPC H04W 52/346; H04W 52/367

(57) ABSTRACT

Techniques are provided for a network-controlled repeater (NCR) to share power during the simultaneous transmission of a control link and backhaul link. When the total power for transmitting via the control link and the backhaul link are below a maximum power for transmission, the NCR can use the calculated transmission powers for transmitting each link. Otherwise, the NCR can apply a relative priority to the links, a default priority to each link, a stepwise reduction of power, or a power sharing factor. A power sharing technique can be based on whether there is overlap between the links on the same time symbol, where the same or different beams are used for each link, and/or whether a priority flag for an access link is being used. These and many other features and examples are described.

### CROSS-REFERENCE TO RELATED APPLICATIONS

This application claims the benefit of U.S. Provisional Application No. 63/596,105, filed Nov. 3, 2023, the content of which is incorporated herein by reference in its entirety for all purposes.

### FIELD

This disclosure relates to wireless communication networks and devices.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling network nodes and access points to communicate with one another in a variety of ways. In some scenarios, base stations and UEs can communicate via an intermediary device, such as a network-controlled repeater (NCR).

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example network according to one or more implementations described herein.

FIG. 2 is a diagram of an example of a network-control repeater (NCR) according to one or more implementations described herein.

FIG. 3 is a diagram of an example process for transmission power sharing between a control link and a backhaul link according to one or more implementations described herein.

FIG. 4 is a diagram of an example for modifying a transmission power of simultaneous transmissions based on link priority according to one or more implementations described herein.

FIG. 5 is a diagram of an example process for modifying a transmission power of simultaneous transmissions based on symbol overlap according to one or more implementations described herein.

FIG. 6 is a diagram of an example of modifying a transmission power of simultaneous transmissions based on the use of one or more beams according to one or more implementations described herein.

FIG. 7 is a diagram of an example of identifying link priority based on a priority flag according to one or more implementations described herein.

FIG. 8 is a diagram of an example of components of a device according to one or more implementations described herein.

FIG. 9 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless networks can include user equipment (UEs) capable of communicating with base stations, wireless routers, satellites, and other network nodes. Such devices can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE can refer to a smartphone, tablet computer, wearable wireless device, a vehicle capable of wireless communications, and/or another type of a broad range of wireless-capable device.

In some networks, a base station can communicate with a UE via a network-control repeater (NCR). In short, the NCR can operate to extend the coverage area of the base station. The base station can communicate with the NCR via a control link and a backhaul link. The control link can enable the base station to configure and manage the NCR. The backhaul link, in combination with an access link, can provide a channel through which data is communicated between the base station and the UE. The channels or beams used for the backhaul link and the control link can be static or fixed and can be line-of-sight (LOS) beams. Additionally, some NCRs can include an NCR mobile termination (NCR-MT) component and an NCR forwarding (NCR-FWD) component that share a radio frequency (RF) unit to communicate with a base station. The NCR may, on occasion, simultaneously transmit using the control link and the backhaul link. However, the NCR can be configured with a maximum transmission power which can be exceeded by the combined transmission powers of the control link and the backhaul link. Currently available technologies fail to provide any, or adequate, solutions for such scenarios.

Techniques described herein address the deficiencies of currently available technology by providing solutions that enable an NCR to share transmission power between the simultaneous transmission of a control link and a backhaul link. The NCR can calculate an individual transmission power for each link and combine the individual transmission powers to determine a total transmission power. When the total power for simultaneously transmitting via both links is below a maximum transmission power, the NCR can use the individual transmission powers for transmitting simultaneously via each link. Otherwise, the NCR can modify the transmission powers of each links based on a relative priority of each link, a default priority of each link, according to a stepwise reduction of transmission power technique applied to each link, or according to a power sharing factor applied to each link. A described herein, the power sharing technique applied to the links can be based on whether there is overlap between the links on the same time symbol, where the same or different beams are used for each link, and/or whether a priority flag for an access link is being used. Simultaneous transmissions, as described herein, can include two or more transmissions that overlap with one another in a time domain and/or in a frequency domain. These and many other features and examples are described below with reference to the Figures.

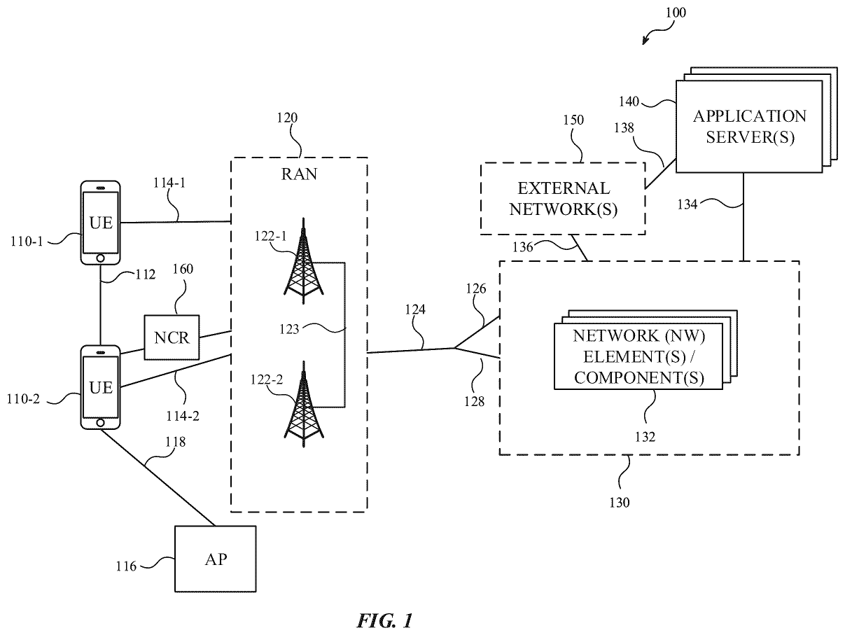

FIG. 1 is an example network 100 according to one or more implementations described herein. Example network 100 can include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSc) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 110 can communicate and establish a connection with one or more other UEs 110 via one or more wireless channels 112, each of which can comprise a physical communications interface/layer. The connection can include an M2M connection, MTC connection, D2D connection, SL connection, etc. The connection can involve a PC5 interface. In some implementations, UEs 110 can be configured to discover one another, negotiate wireless resources between one another, and establish connections between one another, without intervention or communications involving RAN node 122 or another type of network node. In some implementations, discovery, authentication, resource negotiation, registration, etc., can involve communications with RAN node 122 or another type of network node.

UEs 110 can use one or more wireless channels 112 to communicate with one another. As described herein, UE 110-1 can communicate with RAN node 122 to request SL resources. RAN node 122 can respond to the request by providing UE 110 with a dynamic grant (DG) or configured grant (CG) regarding SL resources. A DG can involve a grant based on a grant request from UE 110. A CG can involve a resource grant without a grant request and can be based on a type of service being provided (e.g., services that have strict timing or latency requirements). UE 110 can perform a clear channel assessment (CCA) procedure based on the DG or CG, select SL resources based on the CCA procedure and the DG or CG; and communicate with another UE 110 based on the SL resources. The UE 110 can communicate with RAN node 122 using a licensed frequency band and communicate with the other UE 110 using an unlicensed frequency band.

UEs 110 can communicate and establish a connection with (e.g., be communicatively coupled) with RAN 120, which can involve one or more wireless channels 114-1 and 114-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 122-1 and 122-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 130. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network node 122. In some scenarios, RAN 120 can coordinate with core network 130 via interfaces 124, 126, and/or 128.

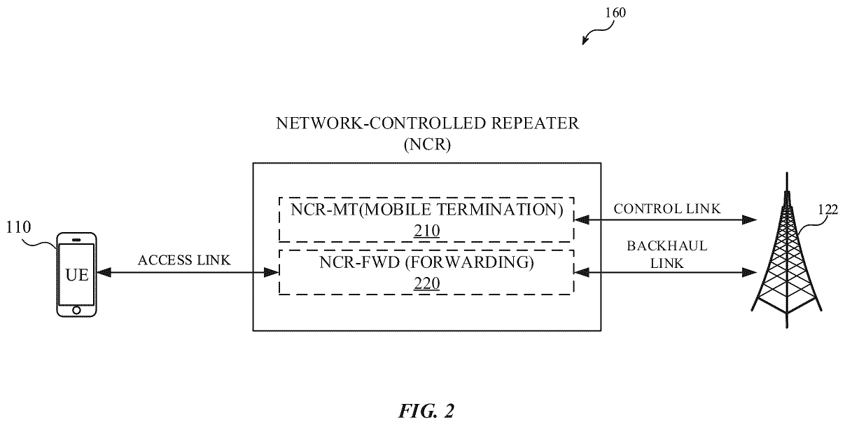

In some implementations, UE 110 and base station 122 can communicate with one another via NCR 160. NCR 160 can operate as a repeater to improve signal quality and/or extend a coverage area of base station 122. NCR 160 can communicate with UE 110 via an access link, and base station 122 via a control link and backhaul link. The control link can enable base station 122 to control the configuration and operation of NCR 160, and the backhaul link can be used to communicate data between base station 122 and UE 110. NCR 160 can be configured to use a fixed beam for the control link and the backhaul link. NCR 160 can implement one or more power sharing techniques to enable NCR 160 to transmit to base station 122 simultaneously via the control link and the backhaul link. An example of NCR 160 is discussed below in greater detail with reference to FIG. 2.

As shown, UE 110 can also, or alternatively, connect to access point (AP) 116 via connection interface 118, which can include an air interface enabling UE 110 to communicatively couple with AP 116. AP 116 can comprise a wireless local area network (WLAN), WLAN node, WLAN termination point, etc. The connection 116 can comprise a local wireless connection, such as a connection consistent with any IEEE 702.11 protocol, and AP 116 can comprise a wireless fidelity (Wi-Fi®) router or other AP. While not explicitly depicted in FIG. 1, AP 116 can be connected to another network (e.g., the Internet) without connecting to RAN 120 or CN 130. In some scenarios, UE 110, RAN 120, and AP 116 can be configured to utilize LTE-WLAN aggregation (LWA) techniques or LTE WLAN radio level integration with IPsec tunnel (LWIP) techniques. LWA can involve UE 110 in RRC_CONNECTED being configured by RAN 120 to utilize radio resources of LTE and WLAN. LWIP can involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling can include encapsulating the entirety of original IP packets and adding a new packet header, thereby protecting the original header of the IP packets.

RAN 120 can include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 can include a roadside unit (RSU), a transmission reception point (TRxP or TRP), and one or more other types of ground stations (e.g., terrestrial access points). In some scenarios, RAN node 122 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 122; a media access control (MAC)/physical (PHY) layer split wherein RRC, PDCP, radio link control (RLC), and MAC layers can be operated by the CRAN/vBBUP and the PHY layer can be operated by individual RAN nodes 122; or a “lower PHY” split wherein RRC, PDCP, RLC, MAC layers and upper portions of the PHY layer can be operated by the CRAN/vBBUP and lower portions of the PHY layer can be operated by individual RAN nodes 122. This virtualized framework can allow freed-up processor cores of RAN nodes 122 to perform or execute other virtualized applications.

In some implementations, an individual RAN node 122 can represent individual gNB-distributed units (DUs) connected to a gNB-control unit (CU) via individual FI or other interfaces. In such implementations, the gNB-DUs can include one or more remote radio heads or radio frequency (RF) front end modules (RFEMs), and the gNB-CU can be operated by a server located in RAN 120 or by a server pool (e.g., a group of servers configured to share resources) in a similar manner as the CRAN/vBBUP. Additionally, or alternatively, one or more of RAN nodes 122 can be next generation eNBs (i.e., gNBs) that can provide evolved universal terrestrial radio access (E-UTRA) user plane and control plane protocol terminations toward UEs 110, and that can be connected to a 5G core network (5GC) 130 via an NG interface.

Any of the RAN nodes 122 can terminate an air interface protocol and can be the first point of contact for UEs 110. In some implementations, any of the RAN nodes 122 can fulfill various logical functions for the RAN 120 including, but not limited to, radio network controller (RNC) functions such as radio bearer management, uplink (UL) and downlink (DL) dynamic radio resource management and data packet scheduling, and mobility management. UEs 110 can be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 122 to UEs 110, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 122 can be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum can include channels that operate in the frequency range of approximately 400 MHz to approximately 3.8 GHZ, whereas the unlicensed band or spectrum can include the 5 GHz band. In an additional or alternative example, an unlicensed spectrum can include the 5 GHZ unlicensed band, a 6 GHz band, a 60 GHz millimeter wave band, and more.

A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 can operate using stand-alone unlicensed operation, licensed assisted access (LAA), eLAA, and/or feLAA mechanisms. In these implementations, UEs 110 and the RAN nodes 122 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 122 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein several CCEs (e.g., 6 or the like) can consist of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, or 16).

Some implementations can use concepts for resource allocation for control channel information that are an extension of the above-described concepts. For example, some implementations can utilize an extended (E)-PDCCH that uses PDSCH resources for control information transmission. The EPDCCH can be transmitted using one or more ECCEs. Similar to the above, each ECCE can correspond to nine sets of four physical resource elements known as an EREGs. An ECCE can have other numbers of EREGs in some situations.

The RAN nodes 122 can be configured to communicate with one another via interface 123. In implementations where the system is an LTE system, interface 123 can be an X2 interface. In NR systems, interface 123 can be an Xn interface. In some implementations, such as a standalone (SA) implementation, interface 123 can be an Xn interface. In some implementations, such as non-standalone (NSA) implementations, interface 123 can represent an X2 interface and an XN interface. The X2 interface can be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 120 can be connected (e.g., communicatively coupled) to CN 130. CN 130 can comprise a plurality of network elements 132, which are configured to offer various data and telecommunications services to customers/subscribers (e.g., users of UEs 110) who are connected to the CN 130 via the RAN 120. In some implementations, CN 130 can include an evolved packet core (EPC), a 5G CN, and/or one or more additional or alternative types of CNs. The components of the CN 130 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 130 can be referred to as a network slice, and a logical instantiation of a portion of the CN 130 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 130, application servers 140, and external networks 150 can be connected to one another via interfaces 134, 136, and 138, which can include IP network interfaces. Application servers 140 can include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 can also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 can include one or more of a variety of networks, including the Internet, thereby providing the mobile communication network and UEs 110 of the network access to a variety of additional services, information, interconnectivity, and other network features.

FIG. 2 is a diagram of an example of a network-control repeater (NCR) 160 according to one or more implementations described herein. As shown, NCR 160 can include one or more NCR mobile termination (NCR-MT) components 210 and one or more NCR forwarding (NCR-FWD) components 220. Generally, NCR 160 and the components of NCR 160 can be implemented as a combination of hardware and software configured to enable NCR 160 to perform the operations, processes, and functions described herein. While not shown, examples hardware components of NCR 160 can include one or more antennas, radio frequency circuitry, baseband circuitry, power management circuitry, application circuitry, inter-component interface circuitry, communication interfaces, processors, memory devices, storage devices, etc. The hardware components can be configured to store, execute, and otherwise support information and software instructions consistent with performing one or more of the techniques described herein.

Generally, NCR 160 can function as a repeater for information between base station 122 (or another type of network access point device) and UE 110. The hardware and software of NCR 160 can be arranged and configured to implement NCR-MT component 210 and NCR-FWD component 220. As shown, NCR-MT component 210 can operate to establish and maintain a control link (C-link) with base station 122. The control link can be based on an NR Uu interface and can enable an exchange of information (e.g., side control information or SCI) between NCR 160 and base station 122. Side control information can enable the configuration and control of NCR-FWD component 220. For example, side control information can be used to indicate beam information (e.g., configured beams), turn beams on or off, indicate a UL-DL TDD configuration, and a behavior of NCR 160 over flexible symbols.

NCR-FWD component 220 can operate to establish a backhaul link with base station 122 and an access link with UE 110. NCR-FWD component 220 can perform amplify-and-forwarding of UL/DL RF signals between gNB and UE via the backhaul link and access link. NCR 160 can configure, modify, and control the functionality of NCR-FWD component 220 based on side control information received from base station 122. The channel/beams for the backhaul link and the control link can be static or fixed and can be LOS beams. A beam used for an access link can be referred to as an access beam or access beam link. A beam used for a backhaul link can be referred to as a backhaul beam or a backhaul link beam. A beam used for a control link can be referred to as a control beam or a control link beam.

NCR 160 can be configured to engage in power sharing for simultaneous transmission via the control link and the backhaul link. NCR 160 can determine an individual transmission power for each link and combine the individual transmission powers to determine a total transmission power. When the total transmission power is below a maximum transmission power (e.g., a total transmission power for which NCR 160 is capable or configured), NCR 160 can use the individual transmission powers for transmitting simultaneously via each link. Otherwise, NCR 160 can modify (e.g., reduced) the transmission powers for one or more of the links based on one or more techniques. Examples of such techniques can include modifying one or more of the individual transmission powers based on a relative priority associated with each link, based on a default priority for each link, according to a stepwise reduction of transmission power technique, according to a power sharing factor applied to each link, etc. Additional details and examples of such techniques are described below with reference to the Figures that follow.

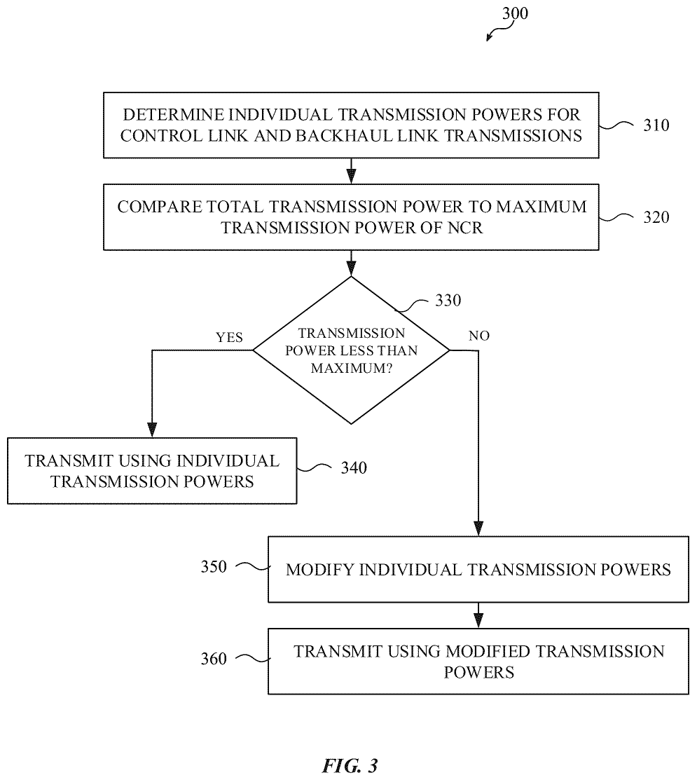

FIG. 3 is a diagram of an example process 300 for transmission power sharing between a control link and a backhaul link according to one or more implementations described herein. Process 300 can be implemented by NCR 160. In some implementations, process 300 can be implemented by NCR-MT 210 and/or NCR-FWD 222. In some implementations, some or all of process 300 can be performed by, or in combination with, one or more other systems or devices, including one or more of the devices of FIG. 1.

Additionally, process 300 can include one or more fewer, additional, differently ordered and/or arranged operations than those shown in FIG. 3, including other processes and/or operations discussed herein. For example, process 300 can include operations preceding, performed in parallel with, and/or following one or more of the depicted operations. Furthermore, some or all the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

While not shown, NCR 160 can receive control or configuration information from base station 122. The information can cause NCR 160 to implement one or more of the transmission power sharing techniques described herein. For examples, the control or configuration information can cause NCR 160 to implement transmission power sharing based on a relative priority of the control link and backhaul link, a default priority for each link, a stepwise reduction of transmission power technique, a power sharing factor applied to each link, or a combination thereof. Accordingly, NCR 160 can be capable of switching between transmission power sharing techniques, and/or enable/disable power sharing techniques, based on configuration information or instructions received from base station 122.

Process 300 can include determining a transmission power for a control link and a transmission power for a backhaul link (block 310). For example, NCR 160 can detect or determine that simultaneous UL transmissions are scheduled for the control link and the backhaul link. Simultaneous transmissions, as described herein, can include two or more transmissions that overlap with one another in a time domain and/or a frequency domain. NCR 160 can determine an individual transmission power for the control link and an individual transmission power for the backhaul link. An individual transmission power, as described herein, can include a transmission power that NCR 160 is configured to apply to a particular transmission in isolation (e.g., irrespective of an overlapping transmission from NCR 160).

Process 300 can include comparing a total transmission power of simultaneous transmissions to a maximum UL transmission power of NCR 160 (block 320). For example, NCR 160 can combine the individual transmission power of the control link transmission to the individual transmission power of the backhaul link transmission to determine a total transmission power for the simultaneous UL transmissions. NCR 160 can also determine a maximum transmission power of NCR 160 for UL transmissions. The maximum transmission power can be based on a static or semi-static parameter indicating the maximum transmission power of NCR 160. In some implementations, the maximum transmission power can be configured by control information from base station 122. NCR 160 can compare the total transmission power for simultaneous transmissions to the maximum transmission power of NCR 160. An individual transmission power for the control link can be determined as P_{NCR}_{_{ULcontrol,calculated}}. A individual transmission power or amplifying gain for the backhaul link can be, for example, fixed via orbital angular momentum (OAM) or determined as P_{NCR}_{_{ULbackhaul}}, which can vary based on the implementation or scenario. A total transmit power can be determined as P_{TOTAL}=P_{NCR}_{_{ULcontrol,calculated}}+P_{NCR}_{_{ULbackhaul}}. The maximum transmit power can be determined a P_{NCR}_{_{UL,}}max. When the total transmission power is less than the maximum transmission power (block 330—Yes), process 300 can include using the individual transmission powers for the simultaneous transmissions (block 340). For example, when the combined transmission powers for the control link and backhaul link is less than (or equal to) the maximum UL transmission power of NCR 160, NCR 160 can proceed to simultaneously transmit via the control and backhaul links according to the individual transmission powers associated with each link. For example, when P_{TOTAL} is less than or equal to P_{NCR}_{_{UL,}}max, NCR 160 can use P_{NCR}_{_{ULcontrol,calculated}} for the control link transmission and P_{NCR}_{_{ULbackhaul}} (or a transmission power fixed via OAM) for the backhaul link transmission.

When the total transmission power is less than the maximum transmission power (block 330—No), process 300 can include modifying a transmission power of simultaneous transmissions (block 350). For example, when the total transmission power for the control and backhaul links exceeds the maximum UL transmission power of NCR 160, NCR 160 can apply one or more transmission power sharing techniques to the control link and the backhaul link. For instance, when P_{TOTAL} is greater than P_{NCR}_{_{UL,}}max, NCR 160 can modify P_{NCR}_{_{ULbackhaul}} and/or P_{NCR}_{_{ULbackhaul}} using one or more transmission power modification techniques (also referred to herein as transmission power sharing techniques).

The transmission power sharing techniques can modify (e.g., decrease) the UL transmission powers for the control link and/or backhaul link, such that the total transmission power no longer exceeds the maximum UL transmission power of NCR 160. Examples of such techniques can include modifying one or more of the individual transmission powers based on: a relative priority associated with each link; based on a default priority for each link; and/or according to a stepwise reduction of transmission power technique; according to a power sharing factor applied to each link.

Upon applying a transmission power sharing technique, process 300 can include using the modified UL transmission powers for the simultaneous transmissions (block 360). For example, NCR 160 can proceed to use the modified UL transmission powers for the simultaneous transmissions via the control link and backhaul link. Accordingly, process 300 can enable transmission power sharing between a control link and a backhaul link when the initial transmission power would exceed a maximum transmission power of NCR 160. Details and examples of transmission power sharing techniques are described below with reference to the Figures that follow.

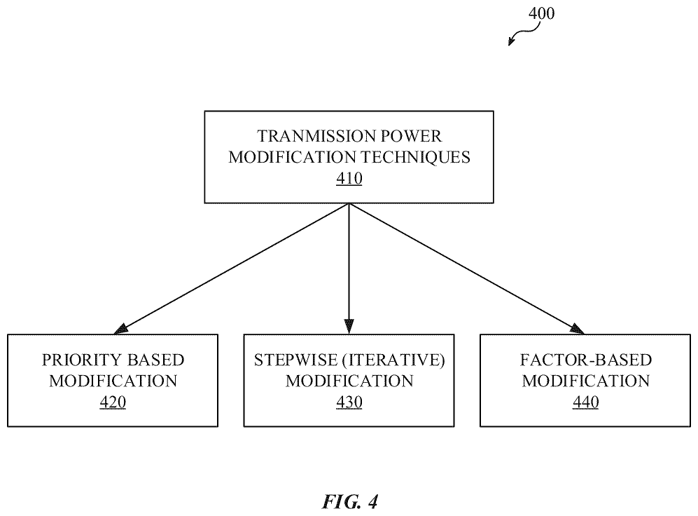

FIG. 4 is a diagram of an example 400 for modifying a transmission power of simultaneous transmissions based on link priority according to one or more implementations described herein. As shown, transmission power modification techniques 410 can include priority based modification 420, stepwise (or iterative) modification 430, and factor-based modification 440. One or more transmission power modification techniques 410 can be implemented by NCR 160. Additionally, in some implementations, transmission power modification techniques 410 can include one or more fewer, additional, or alternative techniques for modifying a transmission power of a control link and/or backhaul link.

Priority based modification 420 can include modifying or reducing the individual transmission power of the control link and/or backhaul link based on a relative priority of the links. In some implementations, control information can be used to indicate whether the control link or the backhaul link has greater priority for simultaneous UL transmission power purposes. In other implementations, which link has priority can be fixed based upon communication standard specifications. NCR 160 can determine the transmission power for the link with greater priority as the individual transmission power corresponding thereto (e.g., P_{NCR}_{_{ULcontrol,calculated}} or P_{NCR}_{_{ULbackhaul}}). NCR 160 can determine the modified transmission power of the link with lesser priority by subtracting the transmission power of the link with greater priority (e.g., P_{NCR}_{_{ULcontrol,calculated}} or P_{NCR}_{_{ULbackhaul}}) from a maximum transmission power of NCR 160 (e.g., P_{NCR}_{_{UL,}}max).

Stepwise modification 430 can include iteratively modifying or reducing the individual transmission power of the control link and/or backhaul link. For example, a first iteration can include reducing the transmission power of the control link and the backhaul link by a given value (e.g., 0.1 dB). Once reduced, a new total transmission power P_{TOTAL} can be determined and compared to a maximum transmission power P_{NCR}_{_{UL,}}max. This process can repeat until P_{TOTAL} is less than or equal to P_{NCR}_{_{UL,}}max, whereupon NCR 160 can proceed with the simultaneous transmissions. In some implementations, the interactive amount by which transmission powers are modified can be more or less than 0.1 dB. Additionally, or alternatively, each iteration can have a different iterative among (e.g., the iterative amount can increase or decrease with each iteration. In some implementations, NCR 160 can modify the transmission power of the links one at a time and compare a new total transmission power to the maximum transmission power after each modification.

Factor-based modification 440 can include modifying or reducing the individual transmission power of the control link and/or backhaul link by a factor or ratio. For example, NCR 160 can receive control information (from base station 122) that can indicate a power sharing factor to be applied to the transmission power of the control link and/or backhaul link when a combination of their simultaneous UL transmissions exceed a maximum transmission power P_{NCR}_{_{UL,}}max. The factor can apply to the control link, the backhaul link, or both the control link and the backhaul link. In some implementations, different factors can be received for the control link and the backhaul link. In some implementations, the power sharing factor can be a ratio indicating a portion of power to be allocated to one link relative to the other link. In other implementations, the power sharing factor can be another type of value. NCR 160 can apply the power sharing factor to the control link and/or backhaul link such that a new total transmission power P_{TOTAL} can be determined and compared to a maximum transmission power P_{NCR}_{_{UL,}}max. A power sharing factor can be calculated by NCR 160 and/or configured by base station 122 by sending NCR 160 configuration information via the control link.

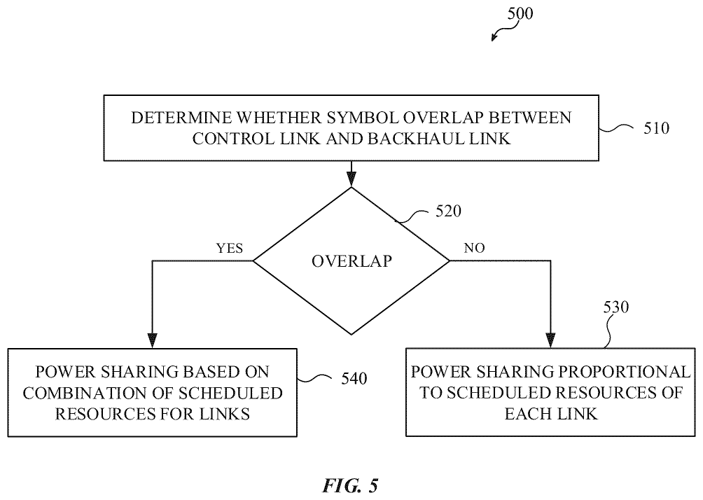

FIG. 5 is a diagram of an example process 500 for modifying a transmission power of simultaneous transmissions based on symbol overlap according to one or more implementations described herein. Process 500 can be implemented by NCR 160. In some implementations, process 500 can be implemented by NCR-MT 210 and/or NCR-FWD 222. In some implementations, some or all of process 500 can be performed by, or in combination with, one or more other systems or devices, including one or more of the devices of FIG. 1. Additionally, process 500 can include one or more fewer, additional, differently ordered and/or arranged operations than those shown in FIG. 5, including other processes and/or operations discussed herein. For example, process 500 can include operations preceding, performed in parallel with, and/or following one or more of the depicted operations. Furthermore, some or all the operations of process 500 can be performed independently, successively, simultaneously, etc., of one or more of the other operations of process 500. As such, the techniques described herein are not limited to a number, sequence, arrangement, timing, etc., of the operations or processes depicted in FIG. 5.

Process 500 can pertain to using a resource dependent power sharing factor for an overlapping symbol between the control link and the backhaul link. As shown, process 500 can include determining whether there is a symbol overlap between the control link and the backhaul link (block 510). For example, NCR 160 can determine that a symbol in a UL transmission via the control link overlaps with a symbol in the UL transmission via the backhaul link. When there is no symbol overlap (block 520—No), process 500 can include

implementing power sharing based on factors proportional to the scheduled resources for each link (block 530). For example, in response to verifying that the control link and the backhaul link do not have an overlapping symbol, NCR 160 can implement a power sharing technique using one or more factors that are proportional to the resources scheduled for each link. For instance, if X number of resources are scheduled for the control link and Y number of resources are scheduled for the backhaul link, then a factor equal to X/(X+Y) can be applied to a maximum transmission power for the control link. Similarly, a factor equal to Y/(X+Y) can be applied to a maximum transmission power for the backhaul link. A scheduled resource, as described herein, can refer to a resource element (RE) that has been scheduled or reserved for use. A power sharing factor can be calculated by NCR 160 and/or configured by base station 122 by sending NCR 160 configuration information via the control link. Base station 122 can also configure NCR 160 with one or more power sharing rules (e.g., pre-defined rules for determining and/or allocating transmission power between a control link and a backhaul 1 ink), including different power sharing factors, when to use different power sharing factors, how to determine priority in one or more scenarios, etc.

When there is a symbol overlap or a partial overlap between the control link and the backhaul link (block 520—Yes), process 500 can include implementing power sharing based on factors relative to the combination of scheduled resources for the control link and the backhaul link (block 540). For example, in response to verifying that the control link and the backhaul link do have an overlapping symbol or a partially overlapping symbol, NCR 160 can implement a factor-based power sharing technique that is based on a combination of the scheduled resources for the control link and the backhaul link. For instance, the transmission power factor for the backhaul link can be determined based on a maximum transmission power of the backhaul link and a combination of the scheduled resources for both the control link and the backhaul link. Similarly, the transmission power factor for the control link can be determined based on a maximum transmission power of the control link and a combination of the scheduled resources for both the control link and the backhaul link.

In some implementations, the combination of scheduled resources can be split evenly between the control link and the backhaul link. In other implementations, the combination of scheduled resources can be split according to a configured parameter or setting (e.g., according to configuration information from base station 122). In some implementations, NCR 160 can refrain from transmitting (or “blank”) the overlapping symbol of one of the links. In such implementations, NCR 160 can be configured to select the symbol to be skipped based on a pre-defined rule, based on the link having a lower priority, and/or based on one or more other factors or conditions.

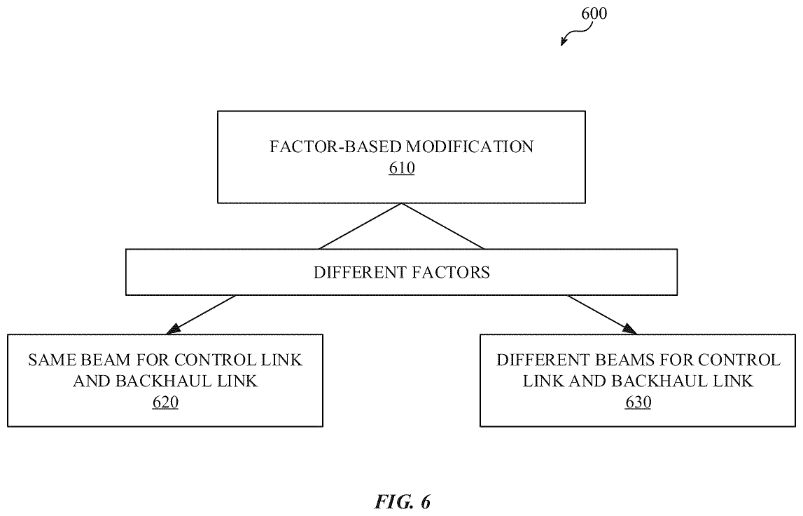

FIG. 6 is a diagram of an example 600 for modifying a transmission power of simultaneous transmissions based on the use of one or more beams according to one or more implementations described herein. As shown, example 600 can include factor-based modification 610. As described herein, NCR 160 can engage in transmission power sharing based, at least in part, on one or more factors being applied to the transmission power of the control link and/or the transmission power of the backhaul link. Examples of such factors can include a simple factor value applied to the transmission powers of the control link and backhaul link, a ratio applied to the transmission powers of the control link and the backhaul link, and/or another type of value to facilitate proper transmission power sharing. As shown in FIG. 6, different factors, and/or types of factors, can be used in different beam scenarios.

For example, one power sharing factor can be used for scenarios that involve the same beam being used for the control link and the backhaul link 620, while another power sharing factor can be used for scenarios involving different beams being used for the control link and the backhaul link 630. Further, different power sharing factors can be used for different links within the same type of beam scenario. For example, when the same beam is used for both links, one power sharing factor can be applied to one type of link and another power sharing factor can be applied to another type of link. Similarly, when different beams are used for each link, one power sharing factor can be applied to one type of link and another power sharing factor can be applied to another type of link. As such, different power sharing factors can be used in different types of beam scenarios.

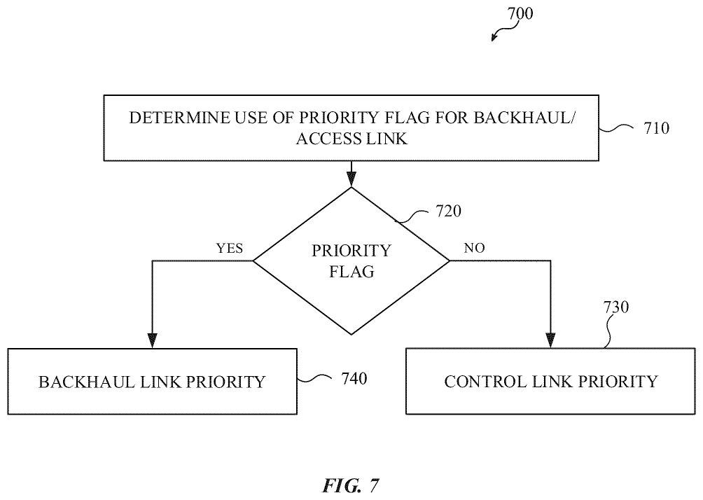

FIG. 7 is a diagram of an example 700 of determining link priority based on a priority flag according to one or more implementations described herein. Process 700 can be implemented by NCR 160. In some implementations, process 700 can be implemented by NCR-MT 210 and/or NCR-FWD 222. In some implementations, some or all of process 700 can be performed by, or in combination with, one or more other systems or devices, including one or more of the devices of FIG. 1. Additionally, process 700 can include one or more fewer, additional, differently ordered and/or arranged operations than those shown in FIG. 7, including other processes and/or operations discussed herein. For example, process 700 can include operations preceding, performed in parallel with, and/or following one or more of the depicted operations. Furthermore, some or all the operations of process 700 can be performed independently, successively, simultaneously, etc., of one or more of the other operations of process 700. As such, the techniques described herein are not limited to the number, sequence, arrangement, timing, etc., of the operations or processes depicted in FIG. 7.

As shown, process 700 can include determining whether a priority flag for a backhaul/access link is in use (block 710). For example, traffic between UE 110 and base station 122 can be marked with a priority flag for data forwarding purposes. The priority flag can be applied to semi-static or periodic forwarding via a backhaul/access link. To determine a priority for power sharing purposes between the control link and the backhaul link, NCR 160 can determine whether a priority flag is, or has been, applied to semi-static or periodic transmissions via the backhaul/access link.

When a priority flag is being applied (block 720—Yes), process 700 can include determining that the backhaul link has priority relative to the control link (block 740). For example, NCR 160 can determine that the backhaul link has priority over the control link when a priority flag is applied for semi-static or periodic forwarding via the backhaul/access link. When a priority flag is not being applied (block 720—No), process 700 can include determining that the control link has priority relative to the backhaul link (block 740). For example, NCR 160 can determine that the control link has priority over the backhaul link when a priority flag is not applied for semi-static or periodic forwarding via the backhaul/access link. However, in some implementations, NCR 160 can still prioritize the backhaul link over the control link when there is overlap between dynamic forwarding via the backhaul link,

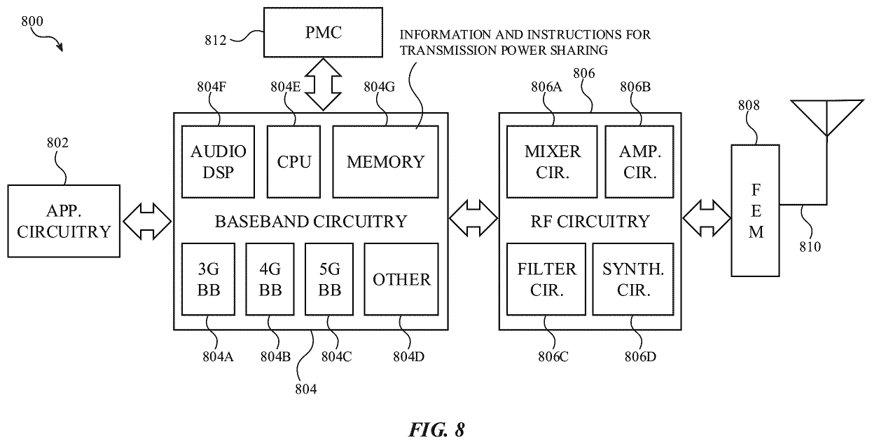

FIG. 8 is a diagram of an example of components of a device according to one or more implementations described herein. In some implementations, device 800 can include application circuitry 802, baseband circuitry 804, RF circuitry 806, front-end module (FEM) circuitry 808, one or more antennas 810, and power management circuitry (PMC) 812 coupled together at least as shown. In some implementations, device 800 can include fewer elements (e.g., a RAN node may not utilize application circuitry 802 and can instead include a processor/controller to process data received from a core network. In some implementations, device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for cloud-RAN (C-RAN) implementations).

Application circuitry 802 can include one or more application processors. For example, application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 800. In some implementations, processors of application circuitry 802 can process data packets received from a core network.

Baseband circuitry 804 can include circuitry such as, but not limited to, one or more single-core or multi-core processors. Baseband circuitry 804 can include one or more baseband processors or control logic to process baseband signals received from a receive signal path of RF circuitry 806 and to generate baseband signals for a transmit signal path of RF circuitry 806. Baseband circuity 804 can interface with application circuitry 802 for generation and processing of the baseband signals and for controlling operations of RF circuitry 806. For example, in some implementations, baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, 7G, etc.). Baseband circuitry 804 (e.g., one or more of baseband processors 804A-D) can handle various radio control functions that enable communication with one or more radio networks via RF circuitry 806. In other implementations, some or all of the functionality of baseband processors 804A-D can be included in modules stored in memory 804G and executed via a central processing unit (CPU) 804E. The radio control functions can include, but are not limited to, signal modulation/demodulation, encoding/decoding, radio frequency shifting, etc. In some implementations, modulation/demodulation circuitry of baseband circuitry 804 can include Fast-Fourier Transform (FFT), precoding, or constellation mapping/de-mapping functionality. In some implementations, encoding/decoding circuitry of baseband circuitry 804 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 804G can receive and store one or more configurations, instructions, and/or other types of information to enable power sharing between simultaneous transmission via a control link and a backhaul link. When the total power for simultaneously transmitting via both links is below a maximum transmission power, the individual transmission powers can be used for each link. Otherwise, the transmission powers for one or both links can be modified (e.g., reduced) based on a relative priority of each link, a default priority of each link, according to a stepwise reduction of transmission power technique applied to each link, or according to a power sharing factor applied to each link. A described herein, power sharing technique applied to the links can be based whether there is overlap between the links on the same time symbol, where the same or different beams are used for each link, and/or whether a priority flag for an access link is being used. These and many other features and examples are described herein and can be enabled by the configurations, instructions, and/or other types of information stored by memory 804G.

In some implementations, baseband circuitry 804 can include one or more audio digital signal processor(s) (DSP) 804F. Audio DSP 804F can include elements for compression/decompression and echo cancellation and can include other suitable processing elements in other implementations. Components of baseband circuitry 804 can be suitably combined in a single chip, a single chipset, or disposed on a same circuit board in some implementations. In some implementations, some or all of the constituent components of baseband circuitry 804 and application circuitry 802 can be implemented together such as, for example, on a system on a chip (SOC).

In some implementations, baseband circuitry 804 can provide for communication compatible with one or more radio technologies. For example, in some implementations, baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, RF circuitry 806 can include switches, filters, amplifiers, etc., to facilitate the communication with the wireless network. RF circuitry 806 can include a receive signal path which can include circuitry to down-convert RF signals received from FEM circuitry 808 and provide baseband signals to baseband circuitry 804. RF circuitry 806 can also include a transmit signal path which can include circuitry to up-convert baseband signals provided by baseband circuitry 804 and provide RF output signals to FEM circuitry 808 for transmission.

In some implementations, the receive signal path of RF circuitry 806 can include mixer circuitry 806A, amplifier circuitry 806B and filter circuitry 806C. In some implementations, the transmit signal path of RF circuitry 806 can include filter circuitry 806C and mixer circuitry 806A. RF circuitry 806 can also include synthesizer circuitry 806D for synthesizing a frequency for use by mixer circuitry 806A of the receive signal path and the transmit signal path. In some implementations, mixer circuitry 806A of the receive signal path can be configured to down-convert RF signals received from FEM circuitry 808 based on the synthesized frequency provided by synthesizer circuitry 806D. Amplifier circuitry 806B can be configured to amplify the down-converted signals and filter circuitry 806C can be a low-pass filter (LPF) or band-pass filter (BPF) configured to remove unwanted signals from the down-converted signals to generate output baseband signals. Output baseband signals can be provided to baseband circuitry 804 for further processing. In some implementations, the output baseband signals can be zero-frequency baseband signals, although this may not be a requirement. In some implementations, mixer circuitry 806A of the receive signal path can comprise passive mixers, although the scope of the implementations is not limited in this respect.

In some implementations, mixer circuitry 806A of the transmit signal path can be configured to up-convert input baseband signals based on the synthesized frequency provided by synthesizer circuitry 806D to generate RF output signals for FEM circuitry 808. The baseband signals can be provided by baseband circuitry 804 and can be filtered by filter circuitry 806C. In some implementations, mixer circuitry 806A of the receive signal path and mixer circuitry 806A of the transmit signal path can include two or more mixers and can be arranged for quadrature down conversion and up conversion, respectively. In some implementations, mixer circuitry 806A of the receive signal path and mixer circuitry 806A of the transmit signal path can include two or more mixers and can be arranged for image rejection. In some implementations, mixer circuitry 806A of the receive signal path and mixer circuitry 806A can be arranged for direct down conversion and direct up conversion, respectively. In some implementations, mixer circuitry 806 of the receive signal path and mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 806 can include analog-to-digital converter (ADC) and digital-to-analog converter (DAC) circuitry and baseband circuitry 804 can include a digital baseband interface to communicate with RF circuitry 806.

In some dual-mode implementations, a separate radio integrated circuitry can be provided for processing signals for each spectrum, although the scope of the implementations is not limited in this respect. In some implementations, synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

Synthesizer circuitry 806D can be configured to synthesize an output frequency for use by mixer circuitry 806A of RF circuitry 806 based on a frequency input and a divider control input. In some implementations, synthesizer circuitry 806D can be a fractional N/N+1 synthesizer. In some implementations, frequency input can be provided by a voltage-controlled oscillator (VCO). Divider control input can be provided by either baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of RF circuitry 806 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by cither N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 806 can include an in-phase/quadrature (I/Q)/polar converter.

FEM circuitry 808 can include a receive signal path which can include circuitry configured to operate on RF signals received from one or more antennas 810, amplify the received signals and provide the amplified versions of the received signals to RF circuitry 806 for further processing. FEM circuitry 808 can also include a transmit signal path which can include circuitry configured to amplify signals for transmission provided by RF circuitry 806 for transmission by one or more of the one or more antennas 810. In various implementations, the amplification through the transmit or receive signal paths can be done solely in RF circuitry 806, solely in FEM circuitry 808, or in both RF circuitry 806 and FEM circuitry 808.

In some implementations, FEM circuitry 808 can include a transmit/receive switch to switch between transmit mode and receive mode operation. FEM circuitry 808 can include a receive signal path and a transmit signal path. The receive signal path of FEM circuitry 808 can include a low noise amplifier to amplify received RF signals and provide the amplified received RF signals as an output (e.g., to RF circuitry 806). The transmit signal path of FEM circuitry 808 can include a power amplifier to amplify input RF signals (e.g., provided by RF circuitry 806), and one or more filters to generate RF signals for subsequent transmission (e.g., by one or more of one or more antennas 810).

In some implementations, PMC 812 can manage power provided to baseband circuitry 804. In particular, PMC 812 can control power-source selection, voltage scaling, battery charging, or direct current (DC) to DC (DC-to-DC) conversion. PMC 812 can often be included when device 800 is capable of being powered by a battery, for example, when device 800 is included in a UE. PMC 812 can increase the power conversion efficiency while providing desirable implementation size and heat dissipation characteristics.

While FIG. 8 shows PMC 812 coupled only with baseband circuitry 804. However, in other implementations, PMC 812 can be additionally or alternatively coupled with, and perform similar power management operations for, other components such as, but not limited to, application circuitry 802, RF circuitry 806, or FEM circuitry 808.

In some implementations, PMC 812 can control, or otherwise be part of, various power saving mechanisms of device 800. For example, if device 800 is in an RRC_Connected state, where device 800 is still connected to the RAN node as device 800 expects to receive traffic shortly, then device 800 can enter a state known as discontinuous reception mode (DRX) after a period of inactivity. During this state, device 800 can power down for brief intervals of time and thus save power.

If there is no data traffic activity for an extended period of time, then device 800 can transition off to an RRC_Idle state, where device 800 disconnects from the network and does not perform operations such as channel quality feedback, handover, etc. Device 800 can go into a very low power state and device 800 can perform paging where again device 800 periodically can wake up to listen to the network and then power down again. Device 800 may not receive data in this state; in order to receive data, device 800 can transition back to RRC_Connected state.

An additional power saving mode can allow a device to be unavailable to the network for periods longer than a paging interval (ranging from seconds to a few hours). During this time, the device 800 can be unreachable to the network and can power down completely. Any data sent during this time can incur a large delay and device 800 can assume the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer I can comprise a physical (PHY) layer of a UE/RAN node, described in further detail below.

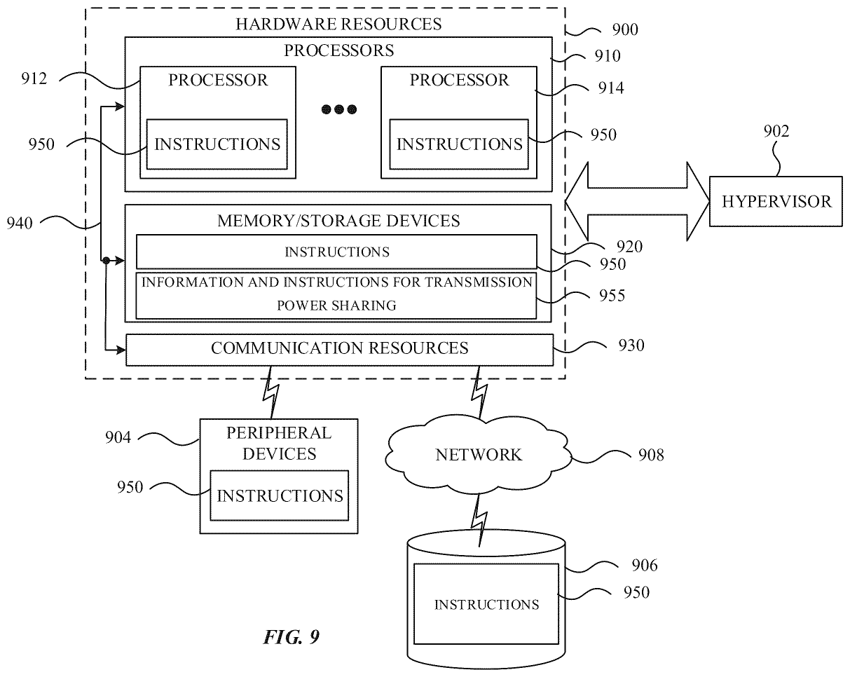

FIG. 9 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors 910 (or processor cores), one or more memory/storage devices 920, and one or more communication resources 930, each of which can be communicatively coupled via a bus 940. For implementations where node virtualization or network function virtualization is utilized, a hypervisor can be executed to provide an execution environment for one or more network slices/sub-slices to utilize hardware resources 900. Hardware resources 900 can interact with hypervisor 902. For example, hypervisor 902 can schedule or otherwise manage hardware resource 900.

Processors 910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 912 and a processor 914.

Memory/storage devices 920 can include main memory, disk storage, or any suitable combination thereof. Memory/storage devices 920 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 920 can receive and store one or more configurations, instructions, and/or other types of information 955 to enable power sharing between simultaneous transmission via a control link and a backhaul link. When the total power for simultaneously transmitting via both links is below a maximum transmission power, the individual transmission powers can be used for each link. Otherwise, the transmission powers for one or both links can be modified (e.g., reduced) based on a relative priority of each link, a default priority of each link, according to a stepwise reduction of transmission power technique applied to each link, or according to a power sharing factor applied to each link. A described herein, power sharing technique applied to the links can be based whether there is overlap between the links on the same time symbol, where the same or different beams are used for each link, and/or whether a priority flag for an access link is being used. These and many other features and examples are described herein and can be enabled by the configurations, instructions, and/or other types of information stored by memory/storage devices 920.

Communication resources 930 can include interconnection or network interface components or other suitable devices to communicate with one or more peripheral devices 904 or one or more databases 906 via a network 908. For example, communication resources 930 can include wired communication components (e.g., for coupling via a universal serial bus), cellular communication components, near field communication components, Bluetooth® components (e.g., Bluetooth® Low Energy), Wi-Fi® components, and other communication components.

Instructions 950A, 950B, 950C, 950D, and/or 950E can comprise software, a program, an application, an applet, an app, or other executable code for causing at least any of processors 910 to perform any one or more of the methodologies discussed herein. Instructions 950 can reside, completely or partially, within at least one of processors 910 (e.g., within a cache memory), memory/storage devices 920, or any suitable combination thereof. Furthermore, any portion of instructions 950A-E can be transferred to hardware resources 900 from any combination of peripheral devices 904 or databases 906. Accordingly, memory of processors 910, memory/storage devices 920, peripheral devices 904, and databases 906 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a network-control repeater (NCR) can comprise a memory; and one or more processors configured to, when executing instructions stored in the memory, cause the NCR to: determine a first transmission power of a first transmission associated with a control link between the NCR and a base station; determine a second transmission power of a second transmission associated with a backhaul link between the NCR and a base station; determine whether a first combination of transmission power, comprising the first transmission power and the second transmission power, exceeds a maximum transmission power of the NCR; and when the first combination of transmission power exceeds the maximum transmission power, modify at least one of the first transmission power, the second transmission power, or both such that a second combination of transmission power is less than or equal to the maximum transmission power of the NCR, and transmit the first transmission and the second transmission according to the second combination of transmission power.

In example 2, which can also include one or more of the examples described herein, the at least one of the first transmission power and the second transmission power is modified based on a priority of the first transmission relative to the second transmission. In example 3, which can also include one or more of the examples described herein, the at least one of the first transmission power and the second transmission power is modified according to a stepwise reduction of power. In example 4, which can also include one or more of the examples described herein, the at least one of the first transmission power and the second transmission power is modified by at least one power sharing factor.

In example 5, which can also include one or more of the examples described herein, the at least one of the first transmission power and the second transmission power is modified by a number of resources of the first transmission relative to a number of resources of the second transmission. In example 6, which can also include one or more of the examples described herein, the first transmission and the second transmission have at least one overlapping symbol, and the at least one of the first transmission power and the second transmission power is modified based on an equal division of the maximum transmission power between the first transmission and the second transmission. In example 7, which can also include one or more of the examples described herein, the first transmission and the second transmission have at least one overlapping symbol, and the at least one of the first transmission power and the second transmission power is modified based on a configured division of transmission power between the first transmission and the second transmission.

In example 8, which can also include one or more of the examples described herein, the first transmission and the second transmission have at least one overlapping symbol, and the at least one of the first transmission power and the second transmission power is modified based on the NCR refraining from transmitting, for the overlapping symbol, at least one of the first transmission and the second transmission. In example 9, which can also include one or more of the examples described herein, the at least one of the first transmission power and the second transmission power is modified based on a power sharing factor associated with a control link and a backhaul link being transmitted using a single beam. In example 10, which can also include one or more of the examples described herein, the at least one of the first transmission power and the second transmission power is modified based on a power sharing factor associated with a control link and a backhaul link being transmitted using different beams.

In example 11, which can also include one or more of the examples described herein, the at least one of the first transmission power and the second transmission power is modified based on a priority of the first transmission relative to the second transmission, and the priority of the first transmission relative to the second transmission is based on a priority flag being applied to a backhaul link and corresponding access link. In example 12, which can also include one or more of the examples described herein, the NCR is further configured to: when the first combination of transmission power does not exceed the maximum transmission power, transmit the first transmission and the second transmission according to the first combination of transmission power.

In example 13, which can also include one or more of the examples described herein, a method, performed by a network-control repeater (NCR), can comprise: determining a first transmission power of a first transmission associated with a control link between the NCR and a base station; determining a second transmission power of a second transmission associated with a backhaul link between the NCR and a base station; determining whether a first combination of transmission power, comprising the first transmission power and the second transmission power, exceeds a maximum transmission power of the NCR; and when the first combination of transmission power exceeds the maximum transmission power, modifying at least one of the first transmission power, the second transmission power, or both such that a second combination of transmission power is less than or equal to the maximum transmission power of the NCR, and transmitting the first transmission and the second transmission according to the second combination of transmission power.

In example 14, which can also include one or more of the examples described herein, a computer-readable medium can comprise one or more instructions that when executed by one or more processors, causes the one or more processors to: determine a first transmission power of a first transmission associated with a control link between the NCR and a base station; determine a second transmission power of a second transmission associated with a backhaul link between the NCR and a base station; determine whether a first combination of transmission power, comprising the first transmission power and the second transmission power, exceeds a maximum transmission power of the NCR; and when the first combination of transmission power exceeds the maximum transmission power, modify at least one of the first transmission power, the second transmission power, or both such that a second combination of transmission power is less than or equal to the maximum transmission power of the NCR, and transmit the first transmission and the second transmission according to the second combination of transmission power.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A network-control repeater (NCR), comprising:
a memory; and
one or more processors configured to, when executing instructions stored in the memory, cause the NCR to:
determine a first transmission power of a first transmission associated with a control link between the NCR and a base station;
determine a second transmission power of a second transmission associated with a backhaul link between the NCR and the base station;
determine whether a first combination of transmission power, comprising the first transmission power and the second transmission power, exceeds a maximum transmission power of the NCR; and
when the first combination of transmission power exceeds the maximum transmission power,
modify at least one of the first transmission power, the second transmission power, or both such that a second combination of transmission power is less than or equal to the maximum transmission power of the NCR, and
transmit the first transmission and the second transmission according to the second combination of transmission power.

2. The NCR of claim 1, wherein the at least one of the first transmission power and the second transmission power is modified based on a priority of the first transmission relative to the second transmission.

3. The NCR of claim 1, wherein the at least one of the first transmission power and the second transmission power is modified according to a stepwise reduction of power.

4. The NCR of claim 1, wherein the at least one of the first transmission power and the second transmission power is modified by at least one power sharing factor.

5. The NCR of claim 1, wherein the at least one of the first transmission power and the second transmission power is modified by a number of resources of the first transmission relative to a number of resources of the second transmission.

6. The NCR of claim 1, wherein:
the first transmission and the second transmission have at least one overlapping symbol, and
the at least one of the first transmission power and the second transmission power is modified based on an equal division of the maximum transmission power between the first transmission and the second transmission.

7. The NCR of claim 1, wherein:
the first transmission and the second transmission have at least one overlapping symbol, and
the at least one of the first transmission power and the second transmission power is modified based on a configured division of transmission power between the first transmission and the second transmission.

8. The NCR of claim 1, wherein:
the first transmission and the second transmission have at least one overlapping symbol, and
the at least one of the first transmission power and the second transmission power is modified based on the NCR refraining from transmitting, for the at least one overlapping symbol, at least one of the first transmission and the second transmission.

9. The NCR of claim 1, wherein the at least one of the first transmission power and the second transmission power is modified based on a power sharing factor associated with a control link and a backhaul link being transmitted using a single beam.

10. The NCR of claim 1, wherein the at least one of the first transmission power and the second transmission power is modified based on a power sharing factor associated with a control link and a backhaul link being transmitted using different beams.

11. The NCR of claim 1, wherein:
the at least one of the first transmission power and the second transmission power is modified based on a priority of the first transmission relative to the second transmission, and
the priority of the first transmission relative to the second transmission is based on a priority flag being applied to a backhaul link and corresponding access link.

12. The NCR of claim 1, wherein the NCR is further configured to:
when the first combination of transmission power does not exceed the maximum transmission power,
transmit the first transmission and the second transmission according to the first combination of transmission power.

13. A method, performed by a network-control repeater (NCR), the method comprising:
determining a first transmission power of a first transmission associated with a control link between the NCR and a base station;
determining a second transmission power of a second transmission associated with a backhaul link between the NCR and the base station;
determining whether a first combination of transmission power, comprising the first transmission power and the second transmission power, exceeds a maximum transmission power of the NCR; and
when the first combination of transmission power exceeds the maximum transmission power,
modifying at least one of the first transmission power, the second transmission power, or both such that a second combination of transmission power is less than or equal to the maximum transmission power of the NCR, and
transmitting the first transmission and the second transmission according to the second combination of transmission power.

14. The method of claim 13, wherein the at least one of the first transmission power and the second transmission power is modified based on a priority of the first transmission relative to the second transmission.

15. The method of claim 13, wherein the at least one of the first transmission power and the second transmission power is modified according to a stepwise reduction of power.

16. The method of claim 13, wherein the at least one of the first transmission power and the second transmission power is modified by at least one power sharing factor.

17. The method of claim 13, wherein the at least one of the first transmission power and the second transmission power is modified by a number of resources of the first transmission relative to a number of resources of the second transmission.

18. A computer-readable medium, comprising one or more instructions that when executed by one or more processors, causes the one or more processors to perform operations comprising:
determine a first transmission power of a first transmission associated with a control link between a network-controlled repeater (NCR) and a base station;
determine a second transmission power of a second transmission associated with a backhaul link between the NCR and the base station;
determine whether a first combination of transmission power, comprising the first transmission power and the second transmission power, exceeds a maximum transmission power of the NCR; and
when the first combination of transmission power exceeds the maximum transmission power,
modify at least one of the first transmission power, the second transmission power, or both such that a second combination of transmission power is less than or equal to the maximum transmission power of the NCR, and
transmit the first transmission and the second transmission according to the second combination of transmission power.

19. The computer-readable medium of claim 18, wherein the at least one of the first transmission power and the second transmission power is modified based on a priority of the first transmission relative to the second transmission.

20. The computer-readable medium of claim 19, wherein the at least one of the first transmission power and the second transmission power is modified according to a stepwise reduction of power.
